(19) United States
(12) Patent Application Publication
(10) Pub. No.: US 2007/0209219 A1
(43) Pub. Date: Sep. 13, 2007

(54) Intuitive fish ruler decal

(76) Inventor: Cory A. Ertmer, Rockton, IL (US)

Correspondence Address: Cory A. Ertmer, 311 Duncan Lane, Rockton, IL, 61072, US

(21) Appl. No.: 11/373,752

(22) Filed: Mar. 10, 2006

(51) Int. Cl. G01D 21/00

(52) U.S. Cl. 33/511

(57) ABSTRACT

An intuitive fish ruler decal that has measurement indicia located within an outline of a fish and which has a zero point that coincides with the nose of the outline of the fish, effectively communicating to the user what the purpose of the ruler is and how it is to be used.

### BACKGROUND OF THE INVENTION

Fishing is a popular sport and leisure activity all over the world, but is particularly popular in North America. Most jurisdictions in North America have rules stating how long a fish of a particular species needs to be in order to keep the fish. These rules stem from ecological concerns that the supply of young fish should not be depleted before they have had a chance to spawn because this could lower fish populations to the point of extinction. For this reason, accurate methods for measuring fish to determine if they should be thrown back into the water after being caught have been developed. However, these methods are deficient for two reasons. First, they have not been adapted to clearly show the user for what purpose they are intended. Second, they do not communicate intuitively how they are to be used.

For example, U.S. Pat. No. 6,115,932 discloses a ruler that has measurement indicia along with pictures of various fresh water fish on it. These pictures are placed near the inch increment, which represents the cutoff line for keeping that particular type of fish. However, this ruler has two problems associated with it. First, the size of the ruler and its measurement indicia are too small for a user to easily measure a fish. Secondly, the ruler does not clearly indicate that the ruler is intended to be used to measure fish because someone could mistake the pictures of the different types of fish as mere decoration. Accordingly, there still exists a need for fish ruler that intuitively communicates to the user for what purpose it is to be used and how it is to be used.

### SUMMARY OF THE INVENTION

The present invention includes a method for using a ruler comprising the following steps. First, providing a ruler that has an outline of an aquatic animal that includes a nose and measurement indicia that has a zero point that substantially coincides with the nose of the outline. Second, placing an aquatic animal such that its nose is coincident with the nose of the outline of the ruler. Third, comparing the location of the tail of the aquatic animal to the measurement indicia found on the ruler. Fourth, releasing the aquatic animal back into the wild depending on the length of the animal that has been measured. This method may also include the step of attaching the ruler to a surface of a boat so that it can be easily accessed while the user is fishing.

The apparatus that can accomplish this method includes a ruler with an outline of an aquatic animal and measurement indicia that is located completely within the outline of the aquatic animal, thereby clearly indicating to the user that the ruler is to be used to measure the aquatic animal. The outline may include at least one extremity and the measurement indicia may be located such that its zero point coincides with this at least one extremity, thereby clearly indicating to the user how to line up an aquatic animal to the ruler for measuring it.

### BRIEF DESCRIPTION OF THE DRAWINGS

FIG. 1 is a front view of the preferred embodiment of the intuitive fish ruler decal.

FIG. 2 is a front view of the preferred embodiment of the intuitive fish ruler decal being used to measure a fish.

### DETAILED DESCRIPTION OF THE PREFERRED EMBODIMENT

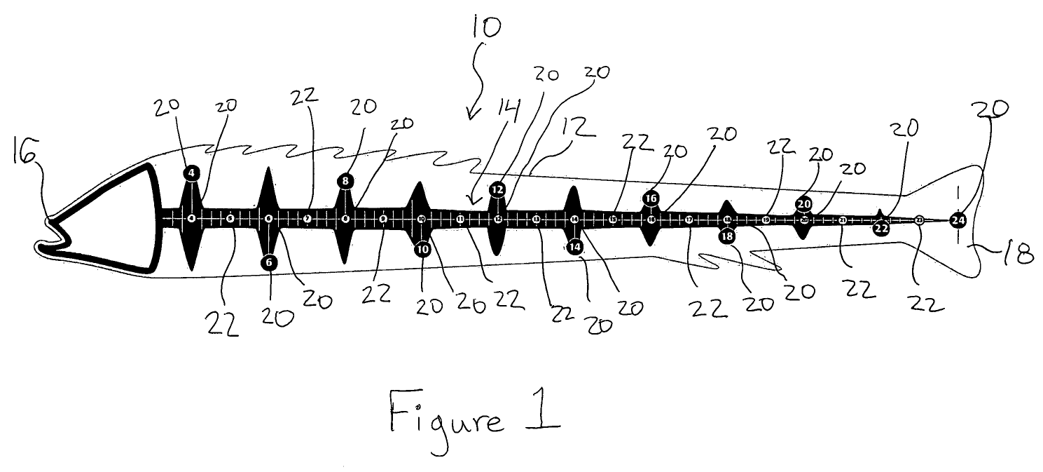

FIG. 1 shows that the preferred embodiment of the present invention is a fish ruler decal 10 that has an outline 12 of a fresh water fish that totally surrounds measurement indicia 14, thereby effectively communicating to the user that the ruler is meant to measure the length of the fish. Preferably, the zero point of the measurement indicia is coincident with the nose 16 of the outline of the fish, providing an intuitive starting place for a user to measure an actual fish (not shown). The measurement indicia starts with the four-inch increment and ends with twenty-four inch increment just shy of the tail 18 of the outline of the fish. This provides the optimal range that allows the user to measure most fresh water fish and know whether or not that fish can be kept.

Furthermore, the even number increments 20 are accentuated as compared to odd number increments 22 by balloons because most cut off dimensions for freshwater fish are specified by even numbers. This allows the user to focus on the critical dimensions more easily when measuring the fish. Also, the way the measurement indicia is laid out simulates the spine of a fish, aiding in the decorative look of the ruler decal 10 and in communicating to the user that the ruler 10 is meant to measure a fish. Finally, it is best to not show any thirty-second fraction of an inch increment because this will tend to make the ruler look too busy, making measurements more difficult to make.

The construction of the decal 10 should include a Protac® clear polyester film that is 2 Mil thick with UV grade inks. This will ensure that the ruler decal 10 will be durable enough to withstand environmental conditions such as precipitation and sunlight during its useful life. These materials are commonly known in the art and constitute the best mode of creating this ruler decal 10. The size of the ruler decal 10 should be 4.125 inches wide and 25.75 inches long with twenty-four-point type of font. These dimensions and type of font ensure that the ruler decal 10 can be easily read.

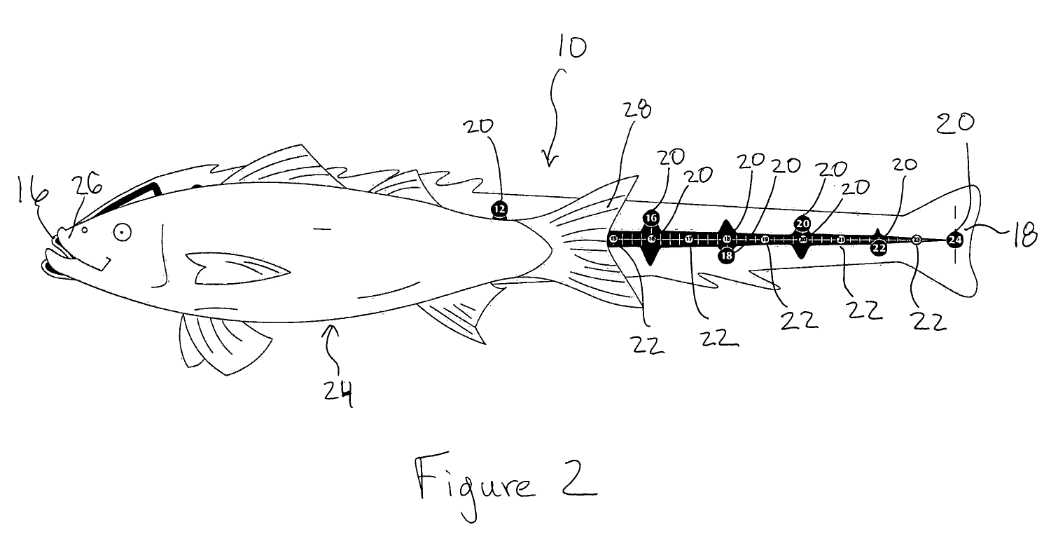

The user should use the ruler decal 10 in the following way. First, the decal 10 is detached from its backing and is adhered to the side of a boat or some other convenient location near where fishing will take place. Once a fish 24 has been caught, the user takes the fish 24 as shown in FIG. 2 and aligns it such its nose 26 is aligned with the nose 26 of the ruler decal 10. Then the tail 28 of the fish 24 is measured to see what inch increment it is closest to on the ruler. The user can then compare that length to the shortest allowable length for that particular species of fish and return the fish 24 to the wild if it is required.

As can be seen, the preferred embodiment of the present invention provides a fish ruler decal 10 that clearly communicates to a user how it is to be used and for what purpose. However, it is clear that those skilled in the art may devise various modifications of the present invention without departing from the spirit and scope of the attached claims. For example, similar rulers are contemplated for use with saltwater fish or other aquatic animals.

What is claimed is:

1. An intuitive ruler for measuring aquatic animals and the like comprising an outline of an aquatic animal that substantially surrounds measurement indicia, thereby clearly indicating to the user that the ruler is meant to be used to measure the aquatic animal.

2. An intuitive ruler for measuring aquatic animals comprising:
an outline of an aquatic animal; and
measurement indicia that is located completely within the outline of the aquatic animal, thereby clearly indicating to the user that the ruler is to be used to measure the aquatic animal.

3. The ruler of claim 2 the outline of the aquatic animal includes at least one extremity and the measurement indicia has a zero point that substantially coincides with the at least one extremity of the outline of the aquatic animal, providing an intuitive place to start to measure the aquatic animal.

4. The ruler of claim 3 wherein the at least one extremity is the nose of the aquatic animal and the outline of the aquatic animal further comprises another extremity that is opposite of the nose of the aquatic animal, which is the tail of the aquatic animal.

5. The ruler of claim 4 wherein the outline of the aquatic animal is the outline of a fresh water fish and the measurement indicia contains inch increments with even numbers that are accentuated as compared to the odd numbers, thereby allowing the user to more easily focus on the even numbers, which communicate whether the fish is long enough to keep.

6. The ruler of claim 5 wherein the measurement indicia starts at four inches and terminates at twenty-four inches, just shy of the tail of the outline of the fish, allowing the user to successfully measure most fresh water fish and know whether or not to keep the fish.

7. The ruler of claim 6 wherein ruler is part of a decal that can be attached to the surface of a boat so that users can measure fish immediately after catching the fish and throw the fish back if the fish is too short.

8. The ruler of claim 2 wherein the measurement indicia is twenty-four point type of font and does not contain any thirty-second fractions of an inch increments.

9. The ruler of claim 2 wherein the measurement indicia is located and configured to simulate the spine of an aquatic animal, thereby clearly communicating that the ruler is adapted for measuring the aquatic animal.

10. The method of using a ruler comprising the following steps:
providing a ruler that has an outline of an aquatic animal including a nose and measurement indicia that is located substantially within the outline and that has a zero point that substantially coincides with the nose of the outline;
placing an aquatic animal such that its nose is coincident with the nose of the outline of the ruler; and
comparing the location of the tail of the aquatic animal to the measurement indicia found on the ruler.

11. The method of claim 9 further comprising the step of releasing the aquatic animal back into the wild depending on the length of the animal that is measured.

12. The method of claim 9 further comprising the step of attaching the ruler to a surface of a boat.
